(19) United States
(12) Patent Application Publication
(10) Pub. No.: US 2007/0076311 A1
(43) Pub. Date: Apr. 5, 2007

(54) Color wheel

(75) Inventor: Yoshio Kubo, Hino-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KABUSHIKI KAISHA TOSHIBA

(21) Appl. No.: 11/392,831

(22) Filed: Mar. 30, 2006

(30) Foreign Application Priority Data
Sep. 30, 2005 (JP) 2005-285756

(51) Int. Cl. G02B 5/22

(52) U.S. Cl. 359/891; 359/892

(57) ABSTRACT

A color wheel is provided with a plurality of color filters, a rotatable shaft to which the color filters are attached to form a disk, and a reinforcing ring covering an outer circumference of the disk of the filters, for reinforcement.

### CROSS-REFERENCE TO RELATED APPLICATIONS

This application is based upon and claims the benefit of priority from Japanese Patent Application No. 2005-285756, filed Sep. 30, 2005, the entire contents of which are incorporated herein by reference.

### BACKGROUND

1. Field

One embodiment of the invention relates to a color wheel for use in a color projector, especially in a color projector of a digital light processing (DLP) type.

2. Description of the Related Art

As is well known, a color projector of a DLP type passes the light from a while-color light source through the red (R), green (G) and blue (B) color filters of a rotating color wheel and projects the light onto the panel surface of a digital micro mirror device (DMD). In synchronism with the light beams that are transmitted from the R, G and B filters on a time divisional basis, the panel surface of the DMD forms optical images corresponding to the R, G and B beams. The optical images are formed by the reflection by a large number of micro mirrors. The R, G and B optical images the DMD forms are enlarged by a projection lens and are projected onto a screen. In this manner, a color image is displayed.

The color wheel used in the DLP type color projector described above is fabricated by adhering fan-shaped color filters to the end face of the rotating shaft of a motor.

Jpn. Pat. Appln. KOKAI Publication No. 9-281426 discloses an optical scanner having a polygon mirror. To suppress the noise the polygon mirror may generate, a transparent heat-shrinkable cylindrical member is attached to the outer circumference of the polygon mirror. However, KOKAI Publication No. 9-281426 does not sufficiently describe specific details of this transparent heat-shrinkable cylindrical member.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 shows an outward appearance of a DLP type color projector according to a first embodiment.

FIG. 2 is a diagram illustrating the outline of a DLP type color projector according to the first embodiment.

FIG. 3 illustrates details of a color wheel according to the first embodiment.

FIG. 4 is a partially-cutaway perspective view illustrating details of the color wheel according to the first embodiment.

FIG. 5 shows connection portions of a ring according to the first embodiment.

FIG. 6 shows one possible shape of the ring according to the first embodiment.

FIG. 7 shows another possible shape of the ring according to the first embodiment.

FIG. 8 shows still another shape of the ring according to the first embodiment.

FIG. 9 shows a further shape of the ring according to the first embodiment.

FIG. 10 shows a still further shape of the ring according to the first embodiment.

### DETAILED DESCRIPTION

Various embodiments according to the invention will be described hereinafter with reference to the accompanying drawings. In general, according to one embodiment of the invention, a color wheel comprises a plurality of color filters, a rotatable shaft to which the color filters are attached to form a disk and a reinforcing ring covering an outer circumferential of the disk of the filters, for reinforcement.

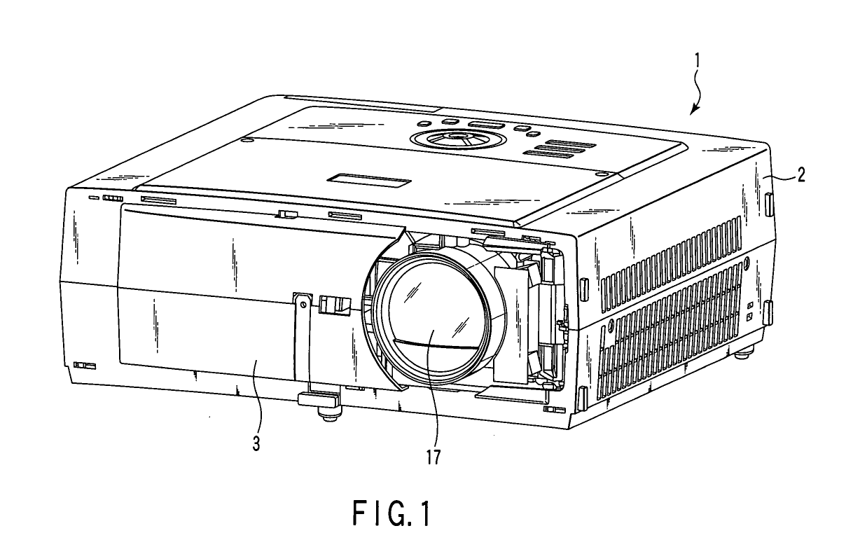

An embodiment of the present invention will now be described with reference to the accompanying drawings. FIG. 1 shows an outward appearance of a DLP type color projector 1 used in an embodiment of the present invention. The DLP type color projector 1 comprises a cabinet 2 which is shaped like a thin box.

The cabinet 2 has a front panel 3 for which a projection lens 17 is provided. The projection lens 17 enlarges an image and projects it on a screen 18 (to be described later), which is an image projection surface.

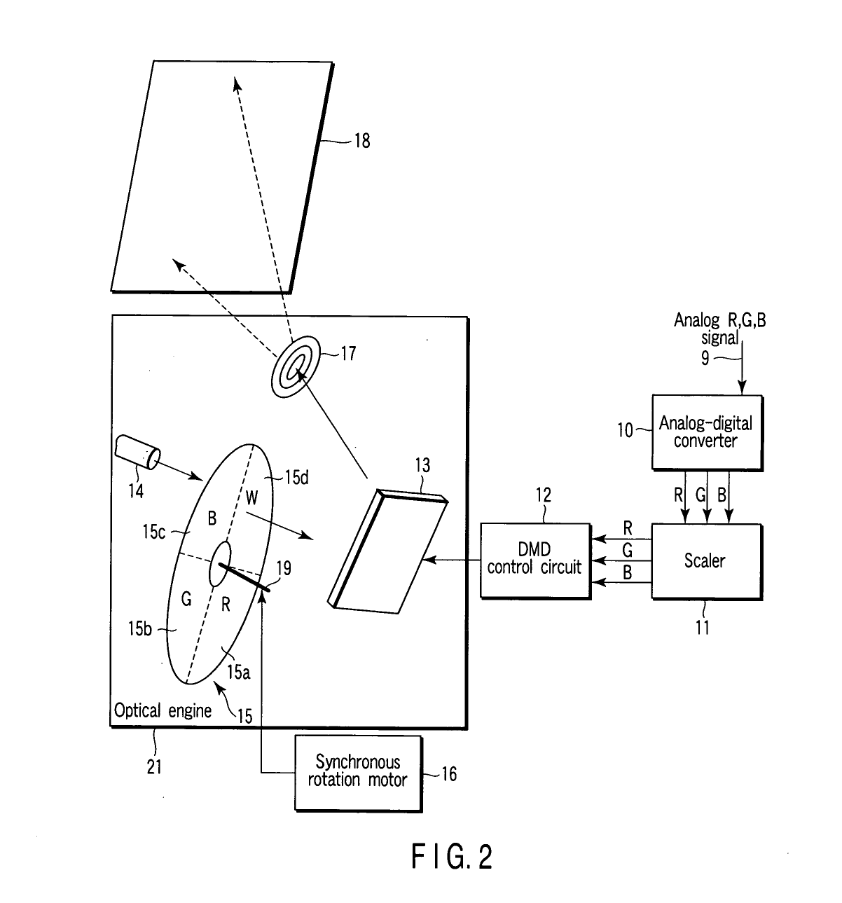

FIG. 2 is a diagram illustrating the outline of a DLP type color projector to which an embodiment of the present invention is applicable. An analog R, G, B signal 9 is led to an analog-digital (A/D) converter 10. The A/D converter 10 digitizes the input R, G, B signal and outputs the digitized signals to a scaler 11.

The scaler 11 serves a panel driver which drives a DMD panel 13 together with a DMD controller 12 of a subsequent stage. The scaler 11 receives digital R, G and B signals and generates R, G and B pixel signals. The R, G and B pixel signals correspond to the resolution (the number of pixels) of a DMD panel 13 connected to the output side of the scaler 11. The scaler 11 adjusts the number of pixels of the R, G and B signals it receives, in such a manner that the adjusted number of pixels corresponds to the micro mirrors (the number of pixels) of the DMD panel 13.

The R, G and B pixel signals output from the scaler 11 are supplied to a DMD control circuit 12. The DMD control circuit 12 generates a white (W) pixel signal on the basis of the R, G and B pixel signals, and supplies this while (W) pixel signal and the R, G and B pixel signals to the DMD penal 13 on a time divisional basis.

Besides the DMD panel 13, the optical engine 21 comprises a light source 14, a color wheel unit 15, a projection lens 17, etc. and functions to project images to a screen 18.

The white light emitted from a light-source lamp 14 passes through the color wheel 15 and then falls on the micro mirror array surface of the DMD panel 13. The color wheel 15 is rotated by a synchronous rotation motor 16 and comprises four filters corresponding to R, G, B and W. The micro mirrors of the DMD panel 13 are driven in accordance with the R, G, B and W pixel signals. In synchronism with the driving operation, a synchronous rotation motor 16 rotates the color wheel 15 in such a manner that light transmitted through the R, G, B and W filters falls on the DMD panel 13 on a time divisional basis.

In accordance with the R, G, B and W pixel signals supplied, the DMD panel 13 switches the reflecting directions of the micro mirror pixels on a time divisional basis. The DMD panel 13 reflects the light that is incident thereon after passing through the color wheel 15, in such a manner that the reflected light (which is colored light) travels toward a lens 17. An enlarged color image output from the lens 17 is projected onto a screen 18. In this manner, the image is displayed.

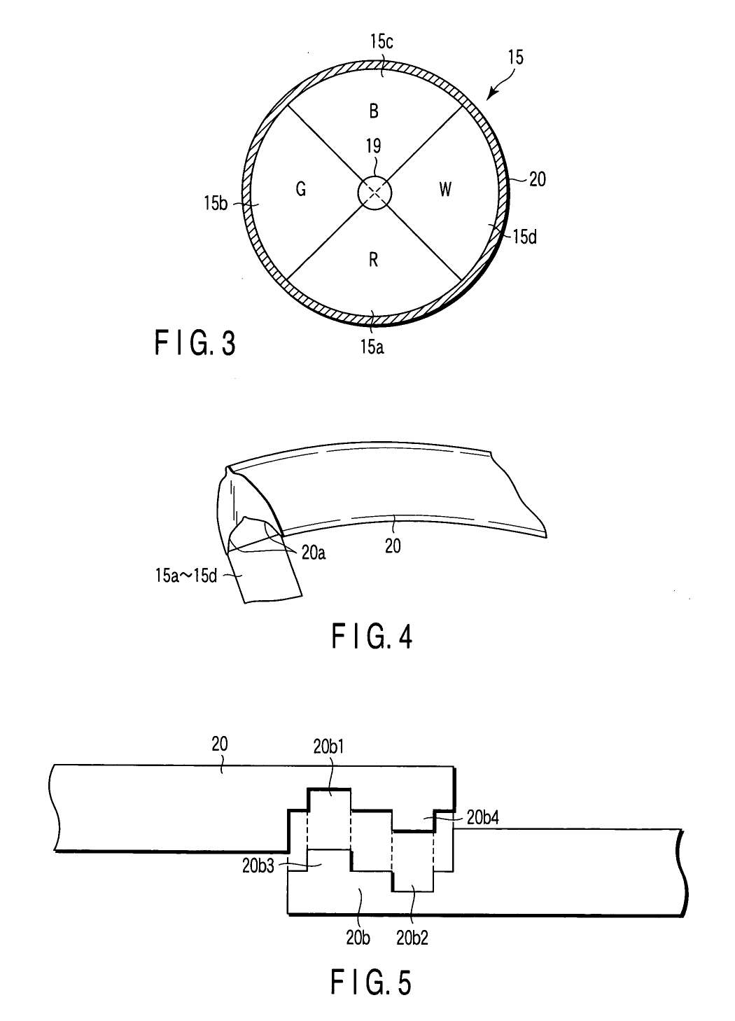

FIG. 3 shows an embodiment of the present invention and illustrates details of the color wheel 15. The color wheel 15 comprises substantially fan-shaped four color filters 15a to 15d. The color filters 15a, 15b, 15c and 15d correspond to R, G, B and W, respectively, and are arranged in such a manner as to be circular. The color filters 15a to 15d are adhered to the end face of the rotating shaft 19 of the synchronous rotation motor 16 at portions that correspond to the center of the circular shape. The outer circumference of the color filters 15a to 15d is covered with a reinforcing ring 20, thereby preventing the color filters 15a to 15d from becoming apart.

FIG. 4 shows how a cross section of the reinforcing ring 20 looks like when it is taken in the direction perpendicular to the rotating direction. As can be seen from FIG. 3, the inner circumferential portion of the reinforcing ring 20 forms clamping portions 20a which hold the outer circumferential portion of the color filters 15a to 15d by clamping it in the thickness direction of the filters 15a to 15d. The outer circumferential portion of the reinforcing ring 20 decreases in thickness from the radially inward portion to the radially outward portion in such a manner that the outer circumferential portion is symmetric with respect to the plane containing the axes passing through the thickness center of each of the color filters 15a to 15d. The outermost portion of the reinforcing ring 20 forms an acute-angle ridge. That is to say, the outermost portion of the reinforcing ring 20 has a smooth surface that hardly generates wind noise during rotation. In other words, the outermost portion of the reinforcing ring 20 is shaped not to cause air resistance.

The outer circumference of the color wheel 15 is covered with the reinforcing ring having the shape described above. With this structure, the outer circumference of the color wheel is not exposed to the atmosphere, and the color filters are prevented from separating. In addition, it is possible to suppress the wind noise the color wheel 15 may generate when it is rotated fast.

As shown FIG. 5, the reinforcing ring 20 has connection portions 20b which are engageable with each other. Because of this structure, the reinforcing ring 20 is easily attachable to the color wheel 15 and detachable therefrom. The connection portions 20b of the reinforcing ring 20 include a plurality of concave portions 20b1 and 20b2 (two concave portions in the embodiment shown in FIG. 5) and a plurality of convex portions 20b3 and 20b4 (two convex portions in the embodiment shown in FIG. 5). In the state where the convex portions 20b3 and 20b4 are fitted in the concave portions 20b1 and 20b2, the connection portions do not cause air resistance when the color wheel 15 is rotated.

The reinforcing ring 20 may be made of a plastic material, such as a metal and plastics. Alternatively, it may be made of an elastic material, such as silicone rubber.

Where the reinforcing ring 20 is made of an elastic material, it does not have to comprise such connection portions 20b as are shown in FIG. 5. The reinforcing ring 20 without connection portions can be attached to the outer circumference of the color wheel 15 by utilizing the elasticity of the material. The elastic material of the reinforcing ring 20 has such elasticity as enables the reinforcing ring 20 to be reliably attached to the color wheel 15. In addition, the elasticity of the elastic material prevents the reinforcing ring 20 from disengaging from the color wheel 15 even when the color wheel 15 is rotated fast. It should be noted that the color wheel 15 can rotate in a stable manner because of the moment of inertia of the reinforcing ring 20.

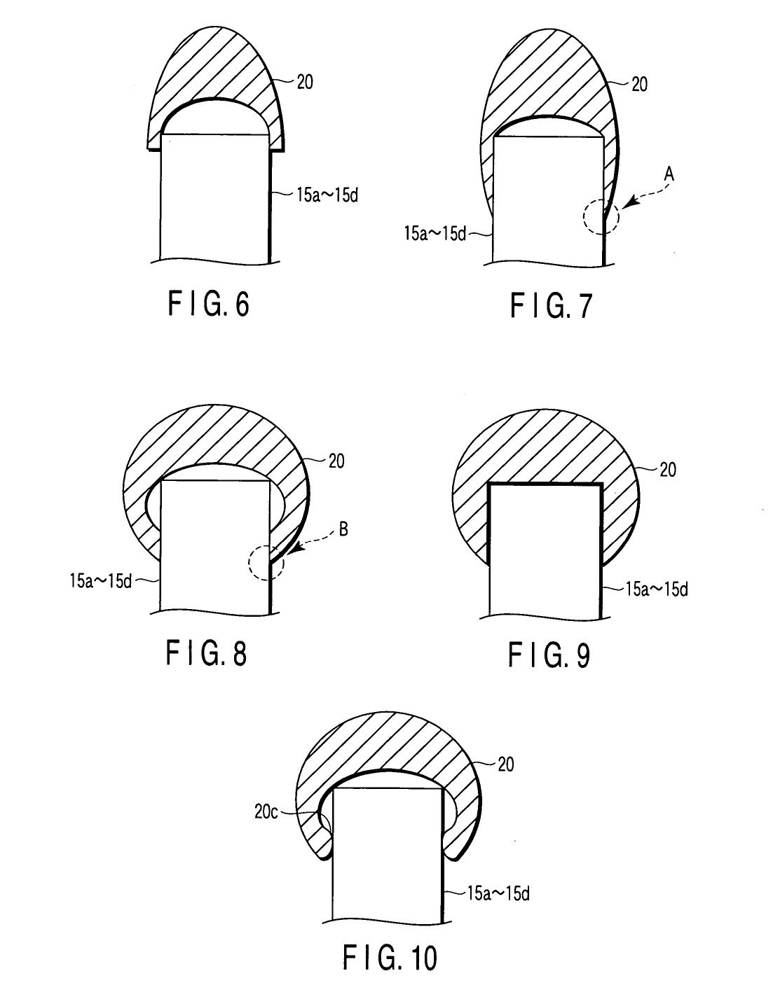

FIGS. 6-10 show modifications of the reinforcing ring 20.

In the modification shown in FIG. 6, the outer circumference surface of the reinforcing ring 20 is curved.

In the modification shown in FIG. 7, the clamping portions 20a of the reinforcing ring 20 can be brought into tight contact with the outer circumferences of the color filters 15a to 15d. As indicated by “A” in FIG. 7, the outer circumference of the clamping portions 20a does not form a rectangular portion projected from the color filters 15a-15d.

In the modification shown in FIG. 8, the tip ends of the clamping portions 20a of the reinforcing ring 20 sandwich the outer circumference of the color filters 15a-15d in the thickness direction of the color filters. In this case as well, the outer circumference of the clamping portions 20a does not form a rectangular portion projected from the color filters 15a-15d.

In the modification shown in FIG. 9, the reinforcing ring 20 is coupled to the outer circumference of the color filters 15a to 15d. The reinforcing ring 20 is in tight contact with the outer circumference, and there is no space between the reinforcing ring 20 and the outer circumference.

In the modification shown in FIG. 10, the tip ends of the clamping portions 20a of the reinforcing ring 20 form engagement portions 20c. The engagement portions 20c causes contact resistance when the reinforcing ring 20 is pulled.

By using the reinforcing ring 20, which can be modified in various manners as described above, the color filters are prevented from becoming apart. In addition, the color wheel does not generate much wind noise when it is rotated fast.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A color wheel comprising:
a plurality of color filters;
a rotatable shaft to which the color filters are attached to form a disk; and
a reinforcing ring covering an outer circumference of the disk of the filters, for reinforcement.

2. The color wheel according to claim 1, wherein the reinforcing ring includes a smooth outer circumferential surface that hardly generates wind noise during rotation.

3. The color wheel according to claim 1, wherein the reinforcing ring includes an inner circumferential portion that forms clamping portions which hold the outer circumferential portion of the color filters by clamping the outer circumferential portion in a thickness direction of the color filters.

4. The color wheel according to claim 1, wherein the reinforcing ring includes connection portions which are engageable with each other.

5. The color wheel according to claim 4, wherein the connection portions of the reinforcing ring include convex and concave portions, the convex portion being detachably fitted into the concave portion.

6. The color wheel according to claim 2, wherein the outer circumferential portion of the reinforcing ring decreases in thickness from a radially inward portion to a radially outward portion such that the outer circumferential portion is symmetric with respect to a plane containing axes passing through thickness center of each of the color filters, the outermost portion of the reinforcing ring forming an acute-angle ridge.

7. The color wheel according to claim 2, wherein the outer circumference surface of the reinforcing ring is curved.

8. The color wheel according to claim 3, wherein the clamping portions do not form a rectangular portion projected from both sides of the color filters.

9. The color wheel according to claim 3, wherein tip ends of the clamping portions of the reinforcing ring sandwich the outer circumference of the color filters in the thickness direction of the color filters.

10. The color wheel according to claim 3, wherein the clamping portions of the reinforcing ring are brought into tight contact with the outer circumferences of the color filters.

11. The color wheel according to claim 3, wherein the clamping portions of the reinforcing ring form engagement portions which cause contact resistance when the reinforcing ring is pulled.

12. A color projector comprising:
a light source;
a color wheel includes: a plurality of color filters, a rotatable shaft to which the color filters are attached to form a disk and a reinforcing ring covering an outer circumference of the disk of the filters, for reinforcement;
control means for rotating the color wheel to allow light emitted from the light source to transmit through the color filter;
a micromirror device which reflects the light transmitted through the color filter of the color wheel by the control means to form an optical image by a plurality of micromirrors; and
a lens through which the light reflected by the micromirror device is projected.

13. The color projector according to claim 12, wherein the reinforcing ring includes a smooth outer circumferential surface that hardly generates wind noise during rotation.

14. The color projector according to claim 12, wherein the reinforcing ring includes an inner circumferential portion that forms clamping portions which hold the outer circumferential portion of the color filters by clamping the outer circumferential portion in a thickness direction of the color filters.

15. The color projector according to claim 12, wherein the reinforcing ring includes connection portions which are engageable with each other.
